(19) United States
(12) Patent Application Publication
(10) Pub. No.: US 2012/0211429 A1
(43) Pub. Date: Aug. 23, 2012

(54) MAGNETIC DISCHARGE OUT OF BOTTLE CLEANING MACHINES

(75) Inventors: Holger Joost, Flensbug (DE); Helmut Browatzki, Esgrus (DE)

(73) Assignee: KRONES AG, Neutraubling (DE)

(21) Appl. No.: 13/396,954

(22) Filed: Feb. 15, 2012

(30) Foreign Application Priority Data
Feb. 17, 2011 (DE) 102011004321.7

(51) Int. Cl. B03C 1/30; B23P 17/04; B01D 33/46; B01D 33/048; B08B 9/20

(52) U.S. Cl. 210/695; 210/223; 134/109; 29/401.1

(57) ABSTRACT

Device for separating ferritic impurities, such as crown caps, out of bottle cleaning machines, including a circulating band screen for the filtration of rinsing water, wherein the band screen is provided with one or more magnetic units.

### CROSS-REFERENCE TO RELATED APPLICATION

The present application claims the benefit of priority of German Application No. 102011004321.7, filed Feb. 17, 2011. The entire text of the priority application is incorporated herein by reference in its entirety.

### FIELD OF THE DISCLOSURE

The disclosure relates to a device for separating ferritic impurities, such as crown caps, out of bottle cleaning machines, including a circulating band screen for the filtration of rinsing water, and to a method for separating ferritic impurities out of bottle cleaning machines.

### BACKGROUND

In connection with bottle cleaning machines/bottle washing machines it is known that residues, typically being deposited at the bottom of the bottle, are rinsed out of the bottle or container by means of a gush directed transversely to the direction of transport. The rinsing liquid containing the detached residues can be flushed laterally into a cleaning chamber, where, for example, used labels can be sucked in by means of a pump and a circulating screening surface, and can be carried away to be finally disposed of. Bottle cleaning machines or bottle cleaning systems frequently comprise a plurality of rinsing zones or rinsing modules in which the bottles are rinsed correspondingly and are freed from residual liquids or dirt. Particularly in a precleaning zone it may happen that metallic closure parts, in particular crown caps, accumulate to a greater extent. In the dirt discharge zone of the bottle cleaning machine, in particular in a lateral cleaning chamber, a fine-meshed band screen provides for a sufficient filtration of the rinsing water, filtering out suspended matter and fibrous components. Suspended matter and fibrous components such as used labels, cigarette filters or the like can thus be removed in a reliable way. Heavy metallic components, and in particular crown caps, sink to the bottom of the dirt discharge zone. Typically, such components do not remain adhered to the band screen. The accumulation of such metallic components can grow so quickly that the band screen is damaged or even destroyed. Ultimately, the operation of the system can come to a standstill. The average performance of a bottle cleaning machine in the high-performance operation is, for example, 60,000 bottles per hour. Typically, such a machine can be operated 150 hours in a seven-day week. This results in an average cleaning performance of 9,000,000 bottles per week. If approximately only every 100th bottle introduces a closure, e.g. a crown cap, into the machine, approximately 90,000 crown caps per week accumulate in the screening device.

### SUMMARY OF THE DISCLOSURE

In view of the problems outlined above, one aspect of the disclosure is to reduce or even avoid the accumulation of impurities, such as ferritic metal pieces/closure pieces or crown caps.

According to the disclosure a device for separating ferritic impurities, such as crown caps, out of bottle cleaning machines is provided, including a circulating band screen for the filtration of rinsing water, wherein the band screen is provided with one or more magnetic units. The magnetic units may be provided directly underneath or on the band screen. Such a device has the advantage that ferritic impurities such as crown caps can be fixed on the band screen by the magnetic force of the one or more magnetic units. Thus, the ferritic impurities fixed on the band screen can be located. The number of the ferritic impurities accumulating in the dirt discharge zone of the side chamber of the cleaning machine can be reduced significantly. Impurities such as crown caps can be carried along with the band screen, and do not fall off the band screen.

Each of the magnetic units of the above-described device may comprise a permanent magnet. Also, each of the above-described magnetic units may comprise an electromagnet. The choice of magnets may depend on system-specific parameters. Also, it is possible to use several magnets in one magnetic unit, or mix the types of magnets.

The above-described device may further comprise a control unit for controlling and switching the magnetic units. The control unit for controlling and switching the magnetic units can be, for example, an electrical control unit having a CPU. Also, it is possible to have an electronic, an electromechanical or a mechanical control unit, by means of which permanent magnets are controllable by pressure. The above-described device may further comprise a suction device with a pump for sucking off the filtered rinsing water. The suction device generates a negative pressure, which sucks the water out of the cleaning plant into the side chamber. As, for example, a suction nozzle is located inside the area enclosed by the band screen, the rinsing water can be sucked through the band screen from a suitable, previously defined direction.

The above-described device may further comprise a cleaning unit, which is adapted to clean the circulating band screen. Cleaning the band screen means that the impurities filtered out of the rinsing liquid by the band screen are removed. This cleaning is carried out, for example, at a suitable position outside a liquid level. Typically, this cleaning is carried out simultaneously with the operation of the band screen. The cleaning may take place continuously. The cleaning unit can comprise, for example, a movably constructed mechanical cleaning member, such as a brush. This brush may be a rotating brush. Alternatively, a reciprocating motion of the brush is feasible. By means of the cleaning unit fibrous components, e.g. used labels or larger suspended matter, price tags etc., which adhere to the band screen, are brushed off the band screen and fall into a collection container. This collection container may also be designed as a collection chute with an exchangeable container placed underneath thereof.

In the above-described device the magnetic units can be attached to the band screen in a spaced manner relative to the longitudinal direction of the band screen. Correspondingly, the band screen can be provided with magnetic units uniformly, or at least have some sections provided at same intervals in which one or more magnetic units are mounted. The magnetic units may be provided individually or in groups. Typically, the magnetic units can be switchable individually or in groups. Typically, the switching or controlling of the magnetic units includes reducing or increasing the magnetic force, in particular switching the magnetic force off and on. The magnetic force of controllable permanent magnets can be reduced, for example, by varying the distance of the permanent magnets from the surface of the band screen, so that the magnetic force generated on the outer side of the band screen can be increased or reduced.

The disclosure further provides for a bottle washing machine for cleaning containers, such as bottles, comprising one or more cleaning modules in the bottle washing machine/bottle cleaning machine, wherein the cleaning modules use a rinsing liquid for cleaning the containers, wherein further the cleaning modules employ a device for separating ferritic impurities, as described above.

The disclosure yet further provides a method for separating ferritic impurities, such as crown caps, out of bottle cleaning machines, comprising a circulating band screen for the filtration of rinsing water, comprising the steps of: filtering the rinsing water through the band screen, carrying off residues adhering to the band screen, wherein ferritic impurities are fixed on the band screen by magnetic force, wherein the band screen comprises one or more magnetic units. The above-described method can further comprise cleaning the band screen from the residues adhering to the band screen by means of a mechanical cleaning unit, such as a brush. Moreover, the method can comprise detaching at least a part of the ferritic impurities fixed on the band screen by reducing or switching off, at least section-wise, the magnetic force. By reducing or switching off the magnetic force the ferritic impurities fixed hitherto can be detached from the band screen at a suitable position, and fall off the band screen, for example under the influence of gravity, into a suitable container or chute so as to be carried off. Switching the magnets on or off section-wise, thus varying the magnetic force, ensures the possibility to be able to transport the ferritic impurities in a well-directed manner to a place outside a liquid level of the rinsing water and to be able to then remove the ferritic impurities from the band screen.

The disclosure further provides a method for retrofitting a bottle cleaning machine, including circulating band screen for the filtration of rinsing water in connection with one or more cleaning modules. To separate ferritic impurities such as crown caps, this method comprises providing the band screen with one or more magnetic units. The one or more magnetic units may be permanent magnets or electromagnets. These magnets can be used in a well-directed manner for fixing ferritic impurities, such as crown caps, through controlling and switching by means of a control unit.

### BRIEF DESCRIPTION OF THE DRAWINGS

The subject matter of the disclosure will be explained by means of an example and the accompanying drawing. In the drawing:

FIG. 1 shows a sketch of a bottle cleaning machine of the prior art, as having a lateral filter chamber or cleaning chamber.

FIG. 2 shows a sectional drawing of a device according to the disclosure for separating ferritic impurities out of a bottle cleaning machine.

FIG. 3 shows a sectional drawing of a band screen having a magnetic unit according to the disclosure.

FIG. 4 shows a sectional drawing of a device for separating ferritic impurities, comprising a circulating band screen for the filtration of rinsing water according to another further development of the disclosure.

### DETAILED DESCRIPTION OF THE PREFERRED EMBODIMENT

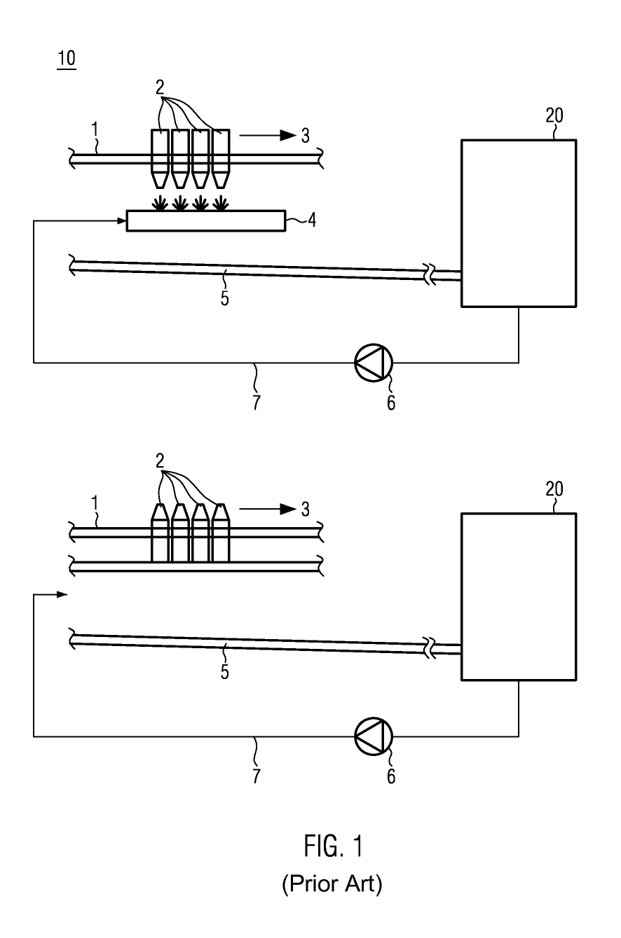

FIG. 1 shows in a sketchy manner a module of a bottle washing machine as known in the prior art. Containers, in particular bottles 2, are transported on a conveyor belt 1. For example, the containers 2 are drawn across strips on the bottom or are suspended upside down. The conveyor belt moves the containers 2 or groups of containers into the transport direction 3 of the conveyor belt 1. At suitable positions, e.g. for precleaning, the containers 2 are sprayed from below with a rinsing liquid, e.g. a lye, by a spraying device 4. The lye flows off again from the containers 2 or out of the containers 2 suspended upside down, and is diverted by a sheet 5 or diversion member. Rinsing water or used rinsing liquid can be conducted, for example, to a filtering or screening unit 20. This screening or filtering unit 20 may be mounted on the side, next to the bottle cleaning machine, in particular not in the transport direction 3 of the conveyor belt 1. Filtered rinsing liquid can be re-supplied to the machine by a pump 6 through a tube 7.

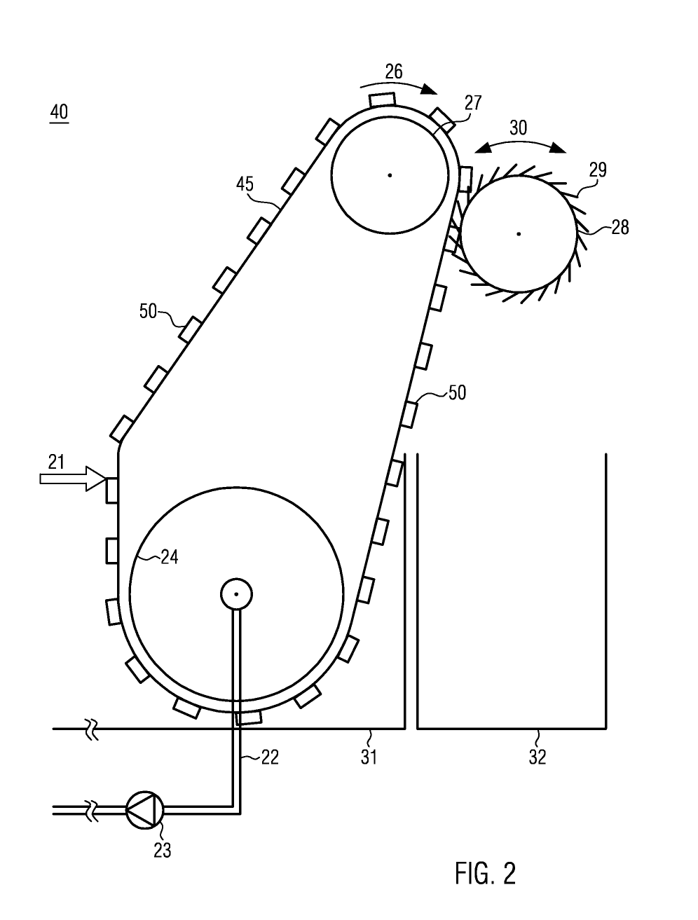

FIG. 2 shows a filtering/screening unit 40 of the present disclosure as usable in a similar configuration as screening unit 20 shown in FIG. 1. A streaming/flow direction of the rinsing water or lye water, respectively, is illustrated by arrow 21. A band screen 45 typically circulating in the circulating direction/running direction 26 runs over a toothed wheel 27 and filters the rinsing water which, flowing from direction 21, is typically pressed through the band screen 45 in the lower area of the band screen 45. The flowing stream of the rinsing liquid is typically produced by a suction unit 24 for sucking off the water or rinsing liquid filtered through the band screen 45. The suction unit sucks off the rinsing water by means of a suction pipe 22, with a pump 23 providing the required suction pressure. If necessary, the sucked-off liquid can then be conducted to a liquid collecting area (not shown). The circulating band screen 45 is able to carry off fibrous residues, typically such as wet used labels or paper fibers, cigarette filters etc., which remain adhered to the outer side of the band screen 45. The outer side of the band screen 45 is the surface of the band screen 45 encountered by the flow to be filtered. Below the band screen 45 a collection container 31 may be provided. The collection container 31 can collect impurities that do not remain adhered to the band screen 45. A brush 28 having brush members or bristles 29 can, for example, brush these residues off the band screen 45, allowing the residues/impurities to fall in a collection container for the brush area 32. The brush 28 can be designed, for example, as a rotary brush. The rotating direction of the brush 28 may be clockwise or counter-clockwise, as indicated by the arrow 30. Also, it is possible to use a brush that is able to carry out a reciprocating motion in one or two dimensions (not shown). In the area of the suction unit 24, for example, another collection container 32 is provided. In particular, this collection container 32 for the area of the suction device and the screening area, respectively, can receive impurities falling down from the band screen 45 or not remaining adhered to it, respectively.

FIG. 2 further shows that the band screen 45 of the present screening unit 40 includes one or more magnetic units 50. These magnetic units 50 are shown schematically in FIG. 2. However, these magnetic units 50 need not be mounted on the outer surface of the band screen 45 or be raised there. It is also conceivable that the magnetic units 50 are mounted only on the lower side of the band screen 45. The use of magnetic units 50, which exert a magnetic force, allows ferritic impurities such as crown caps to adhere to the band screen 45 in the area of the magnetic units 50, instead of falling into the collection container 31. In addition, it should be considered that the transport stream flowing from the direction indicated by arrow 21 can flush impurities like, for example, crown caps into the container 31. These impurities may be those that already fell down before and flow along a diversion member, also see reference number 5 in FIG. 1, into the area of the band screen 45. Thus, there is another source in the area of the band screen 45 causing ferritic impurities such a crown caps to be introduced into this area. Due to the magnetic force the band screen 45 can now be further able to receive ferritic impurities in this area of the container 31. This means that the band screen 45 can additionally cause ferritic impurities in this area to be carried away. The number of crown caps or ferritic impurities introduced into the collection container 31 can thus be reduced.

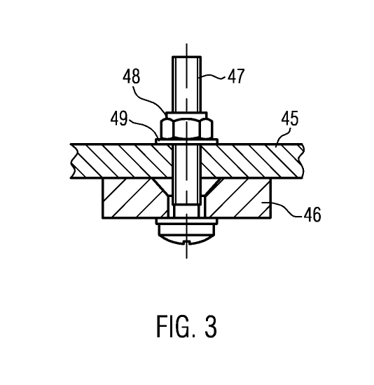

FIG. 3 shows a magnetic unit 50 according to the disclosure as described in FIG. 2. The magnetic unit 50 is formed, for example, of a magnet 46 sitting on the lower side of the band screen 45 and being held by a drive screw 47 connecting the magnet 46 to the band screen 45 by a nut 48 and a washer 49. The magnet 46 may be an electromagnet or a permanent magnet. The magnet 46 may be realized as an electromagnet and connected to a control unit (not shown). The control unit can control the current flow through the electromagnet correspondingly, so that the magnetic force can be switched on or off or increased or reduced, respectively. In case of a permanent magnet also hydraulic control elements may be provided, which are capable of controlling the vertical distance of the permanent magnet relative to the surface of the band screen 45.

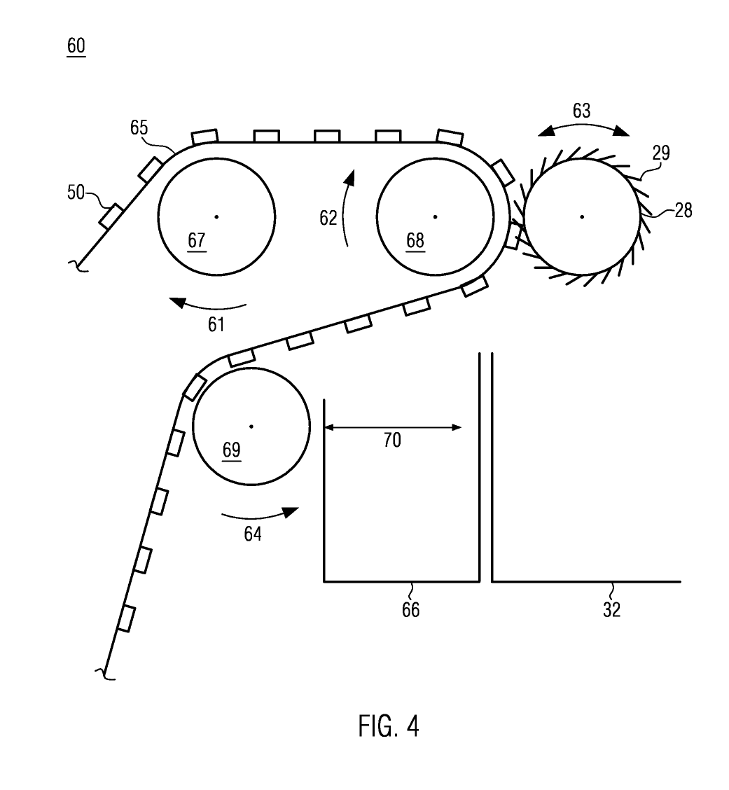

FIG. 4 shows another illustration of a filtering/screening unit 60 according to the present disclosure. A band screen 65 can, again, be provided with one or more magnetic units 50, as is described in FIG. 2 and FIG. 3. In FIG. 4 the band screen 65 runs over a first toothed wheel or transport wheel 67, which resembles the toothed wheel 27 of FIG. 2. As is shown in FIG. 4, the toothed wheel 67 rotates in a direction of rotation 61. Moreover, the band screen 65 may run over additional toothed and transport wheels, as is shown by way of example in the figure. FIG. 4 shows, as an example, a second toothed wheel/transport wheel 68 having a direction of rotation 62, as well as a third toothed wheel or transport wheel 69 having a direction of rotation 64. It is possible, however, to use additional suited toothed and transport wheels to guide the band screen 65. Again, the cleaning member 28 is designed as a brush member. The cleaning member 28 has bristles 29 and is shown, by way of example, as a rotating brush element. The rotating brush member rotates in a direction of rotation 63, for example, clockwise or counter-clockwise. Residues adhering to the band screen 65 can thus be removed by the brush. Typically, the brush is already able to remove at least some of the ferritic impurities, e.g. crown caps, from the band screen 65, i.e. brush them off the band screen 65, although these impurities adhere to the band screen 65 or to the one or more magnetic units 50 due to the magnetic force. These impurities fall into the collection container 32. In addition, a special area having a width 70 is provided. This area is typically located behind/downstream of the area in which the rotating brush has cleaned the outer side of the band screen 65. In relation to the running direction of the band screen 65 and the time sequence of the cleaning operations this area is located downstream of the area in which the brushes have typically removed fibrous impurities from the band screen 65. By controlling the magnetic units 50 the metallic, ferritic impurities such as crown caps can be removed in a well-directed manner from the band screen 65 in the special area having the width 70 by reducing or switching off the magnetic force. The switching and control operations are typically accomplished with the aid of the control unit and, for example, a CPU connected therewith (not shown). By the influence of gravity these crown caps fall then off the band screen 65. The crown caps or ferritic, metallic impurities, respectively, can then be collected in a collection container 66. This collection container 66 may be provided with suited exchange or evacuation mechanisms (not shown) to allow a discharge of the metallic impurities in time. The width 70 of the special area above the collection container 66 can be adapted in an appropriate way in correspondence with the parameters of the inventive bottle cleaning machine having the screening unit 65. In particular, the widths of the collection containers 66 and 32 in FIG. 4 are illustrated merely schematically and may differ from each other. Selectively controlling the magnetic units 50 allows the switching of the magnetic force of individual electromagnets or groups of electromagnets above a selected area and, thus, efficiently controlling the magnetic force and the removal of the ferritic impurities, such as crown caps.

It will be appreciated that features recited in the described embodiments are not limited to the combinations specifically illustrated in the figures, but can be realized in any other combinations as well.

1. A device for separating ferritic impurities out of bottle cleaning machines, comprising a circulating band screen for the filtration of rinsing water, the band screen being provided with one or more magnetic units.

2. The device according to claim 1, wherein each of the magnetic units comprises a permanent magnet.

3. The device according to claim 1, wherein each of the magnetic units comprises an electromagnet.

4. The device according to claim 2, and a control unit for controlling and switching the magnetic units.

5. The device according to claim 1, and a suction device with a pump for sucking off the filtered rinsing water.

6. The device according to claim 1, and a cleaning unit, which is adapted to clean the band screen, the cleaning unit having at least one movably constructed mechanical cleaning member.

7. The device according to claim 1, wherein the magnetic units are attached to the band screen in a spaced manner relative to the longitudinal direction of the band screen.

8. The device according to claim 4, wherein the magnetic units are switchable individually or in groups.

9. The device according to claim 8, wherein the band screen travels through an area of a predefined length, wherein individual magnetic units or groups of magnetic units are switchable in this area to reduce the magnetic force in this area.

10. A bottle washing machine for cleaning containers, comprising one or more cleaning modules which use a rinsing liquid for the cleaning, each with a device according to claim 1.

11. A method for separating ferritic impurities out of bottle cleaning machines, including a circulating band screen (45, 65) for the filtration of rinsing water, comprising:
filtering the rinsing water through the band screen;
carrying off residues adhering to the band screen; and
fixing ferritic impurities on the band screen by magnetic force, wherein the band screen comprises one or more magnetic units.

12. The method according to claim 11, and cleaning the band screen from the residues adhering to the band screen by means of a mechanical cleaning unit.

13. The method according to claim 11, and detaching at least a part of the ferritic impurities fixed on the band screen by reducing or switching off the magnetic force.

14. The method for retrofitting a bottle cleaning machine, comprising a circulating band screen for the filtration of rinsing water, which band screen comprises one or more cleaning modules, to separate ferritic impurities, comprising:
providing the band screen with one or more magnetic units.

15. The method according to claim 14, wherein each of the magnetic units comprises a permanent magnet or an electromagnet.

16. The method according to claim 15, and controlling and switching the magnetic units by means of a control unit.

17. The device according to claim 1, wherein the ferrite impurities are crown caps.

18. The device according to claim 6, wherein the mechanical cleaning member is a brush.

19. The device according to claim 10, wherein the containers are bottles.

20. The method according to claim 12, wherein the mechanical cleaning unit is a brush.

21. The method according to claim 13, wherein the magnetic force is reduced or switched off at least section-wise.

22. The method according to claim 14, wherein the ferritic impurities comprise crown caps.
